(19) United States
(12) Patent Application Publication
(10) Pub. No.: US 2025/0335340 A1
(43) Pub. Date: Oct. 30, 2025

(54) METHOD, DEVICE, AND COMPUTER PROGRAM PRODUCT FOR SELECTING TEST CASES

(71) Applicant: DELL PRODUCTS L.P., ROUND ROCK, TX (US)

(72) Inventors: Zhibin ZHANG, Chengdu (CN); Jingbin WANG, Beijing (CN); Qiyu ZHANG, Beijing (CN)

(21) Appl. No.: 18/733,416

(22) Filed: Jun. 4, 2024

(30) Foreign Application Priority Data
Apr. 26, 2024 (CN) 202410516632.7

(51) Int. Cl. G06F 11/36

(52) U.S. Cl. CPC G06F 11/3684; G06F 11/3698

(57) ABSTRACT

A method includes: acquiring a pull request for a code change. The method further includes: generating one or more change representations of the code change based on the pull request of the code change. In addition, the method further includes: selecting one or more test cases for testing the code change from a test case library based on the one or more change representations of the code change. According to the solutions of the embodiments of the present disclosure, a test case for verifying a code change can be automatically selected, thereby improving testing efficiency, accelerating testing speeds, helping to timely discover and solve problems, and shortening the software development cycle, while reducing the workload of manual selection by a tester, lowering labor costs, and avoiding the influence of human factors on test case selection.

### TECHNICAL FIELD

Embodiments of the present disclosure relate to the field of computers and, in particular, to a method, an apparatus, a device, and a computer program product for selecting test cases.

### BACKGROUND

In software engineering, test cases are a set of conditions or variables that a tester uses to determine whether an application software or software system works correctly. The method for determining whether a software program or system has passed testing is called testing criteria. By executing test cases, it is possible to detect whether a software's behaviors under different conditions meet expectations and to identify potential defects and problems. Test cases are usually written by a tester, covering various scenarios and boundary conditions to comprehensively evaluate the quality of the software.

Selecting appropriate test cases is crucial for software development during software testing. The quality and coverage of the test cases directly affect the stability and reliability of the software. Potential defects and problems may be effectively identified through the carefully selected test cases, so as to ensure that the software can run normally in various situations. Appropriate test cases can cover various functions, boundary conditions, and abnormal situations, and improve the comprehensiveness and effectiveness of testing.

### SUMMARY OF THE INVENTION

The embodiments of the present disclosure provide a method, a device, and a computer program product for selecting test cases.

According to an aspect of the present disclosure, a method for selecting test cases is provided. The method includes: acquiring a pull request (PR) for a code change. The method further includes: generating one or more change representations of the code change based on the pull request of the code change, wherein the change representation at least includes a file name, a function name, and a code line which are associated with the code change. In addition, the method further includes: selecting one or more test cases for testing the code change from a test case library based on the one or more change representations of the code change.

According to another aspect of the present disclosure, an electronic device is provided. The device includes a processing unit and a memory, wherein the memory is coupled to the processing unit and has instructions stored therein. The instructions, when executed by the processing unit, perform the following actions: acquiring a pull request for a code change;
generating one or more change representations of the code change based on the pull request of the code change, wherein the change representation at least comprises a file name, a function name, and a code line which are associated with the code change; and selecting one or more test cases for testing the code change from a test case library based on the one or more change representations of the code change.

According to yet another aspect of the present disclosure, a computer program product is provided. The computer program product is tangibly stored in a non-transitory computer-readable medium and includes computer-executable instructions. The computer-executable instructions, when executed, cause a computer to perform the method or process according to the embodiments of the present disclosure.

The Summary of the Invention section is provided to introduce the selection of concepts in a simplified form, which will be further described in the Detailed Description below. The Summary of the Invention section is neither intended to identify key features or essential features of the present disclosure, nor intended to limit the scope of the embodiments of the present disclosure.

### BRIEF DESCRIPTION OF THE DRAWINGS

By describing the illustrative embodiments of the present disclosure in more detail with reference to the accompanying drawings, the above and other objectives, features, and advantages of the present disclosure will become more apparent. In the illustrative embodiments of the present disclosure, the same reference numerals generally represent the same elements.

FIG. 1 shows a schematic diagram of an example environment in which a device and/or a method according to an embodiment of the present disclosure may be implemented;

FIG. 2 shows a flow chart of a method for selecting test cases according to an embodiment of the present disclosure;

FIG. 3 shows a schematic diagram of a process of constructing a test case library according to an embodiment of the present disclosure;

FIG. 4 shows a schematic diagram of a process of executing code testing according to an embodiment of the present disclosure;

FIG. 5 shows a schematic diagram of a process of evaluating a code change according to an embodiment of the present disclosure;

FIG. 6 shows a schematic block diagram of a device that may be used to implement embodiments of the present disclosure;

In the various accompanying drawings, identical or corresponding reference numerals represent identical or corresponding parts.

### DETAILED DESCRIPTION

Preferred embodiments of the present disclosure will be described in further detail below with reference to the accompanying drawings. While some specific embodiments of the present disclosure are shown in the accompanying drawings, it should be understood that the present disclosure may be implemented in various forms, and should not be limited to the embodiments set forth herein. Rather, these embodiments are provided to make the present disclosure more thorough and complete and to fully convey the scope of the present disclosure to those skilled in the art.

The term “include” and variants thereof used herein indicate open-ended inclusion, that is, “including but not limited to.” Unless specifically stated, the term “or” indicates “and/or.” The term “based on” indicates “based at least in part on.” The terms “an example embodiment” and “an embodiment” indicate “at least one example embodiment.” The term “another embodiment” indicates “at least one additional embodiment.” The terms “first,” “second,” and the like may refer to different or identical objects, unless otherwise specifically indicated.

As mentioned earlier, selecting appropriate test cases is crucial for software development during software testing. However, when selecting test cases at present, it is often necessary for a tester to manually select corresponding test cases, resulting in high labor costs, low scalability, and possible omission of key scenarios in the selection of test cases.

To this end, the embodiments of the present disclosure provide a solution for selecting test cases. Firstly, a pull request for a code change submitted by a developer is acquired. Then, based on these code modification requests, one or more change representations that describe the code modification, including the modified file name, function name, and specific code line, are generated. Finally, based on these change representations, test cases that are suitable for testing these code changes are selected from a test case library.

Thus, through the solutions provided in the embodiments of the present disclosure, a test case for verifying a code change can be automatically selected, thereby improving testing efficiency, accelerating testing speeds, helping to timely discover and solve problems, and shortening the software development cycle, while reducing the workload of manual selection by a tester, lowering labor costs, and avoiding the influence of human factors on test case selection.

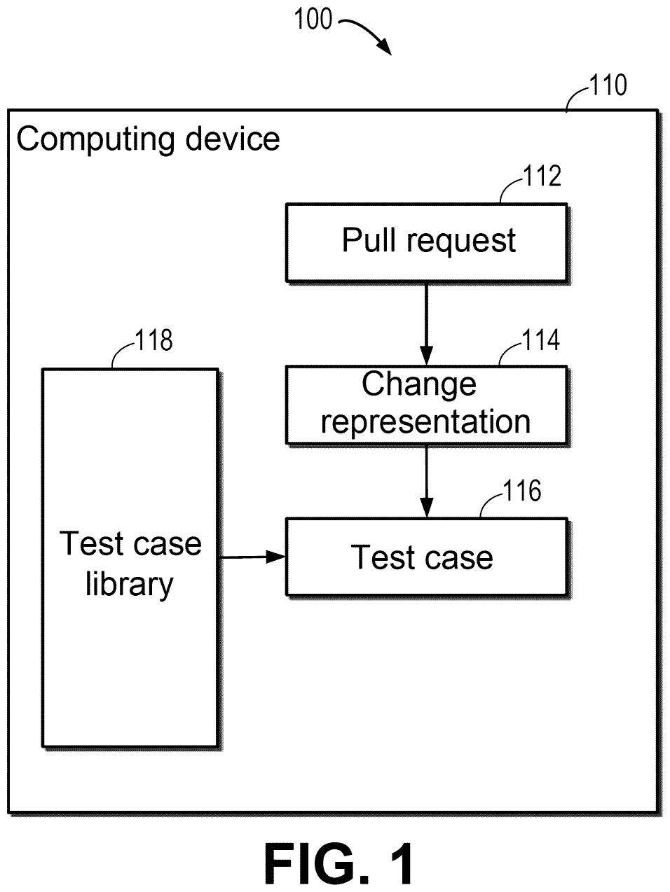

The basic principles and some example implementations of the present disclosure are illustrated below with reference to FIG. 1 to FIG. 6. It should be understood that these illustrative embodiments are given only to enable those skilled in the art to better understand and thus implement the embodiments of the present disclosure, and are not intended to limit the scope of the present disclosure in any way.

FIG. 1 shows an example environment 100 in which a device and/or a method according to an embodiment of the present disclosure may be implemented. As shown in FIG. 1, the example environment 100 may include a computing device 110, which may be a user terminal, a mobile device, a computer, or the like, and may also be a computing system, a single server, a distributed server, or a cloud-based server. By using the computing device 110, test cases may be selected and executed in different environments and scenarios to meet various software development and testing needs.

Referring to FIG. 1, the computing device 110 may acquire a pull request 112 for a code change. The pull request may also be called a pulling request or a merge request. The pull request is a collaborative approach used in open source projects and team development, and is primarily used for code review and merging. When developers complete a portion of work and are ready to merge it into a main codebase, they will create a pull request. When creating a pull request, the developers typically provide a detailed description to explain the modification content, objective, and influence of the code. Other team members may review the code, provide suggestions, or raise questions for discussion and feedback. Because the pull request 112 includes the modification content of the code, a change representation 114 may be generated based on the pull request 112 of the code change, and the change representation may also be referred to as a change vector to represent the code change.

In some embodiments, the change representation 114 may be generated in a predetermined format. In some embodiments, the change representation 114 may be generated in a format of [file name, function name, code line], wherein the file name represents the file involved in the pull request 112 of the code change, the function name represents the function involved in the pull request 112 of the code change, and the code line represents the code line involved in the pull request 112 of the code change. It should be understood that the code change may involve a plurality of files, a plurality of functions, and a plurality of code lines.

Referring to FIG. 1, the test case 116 may be selected from a test case library 118 according to the change representation 114 of the code change. Test cases are a set of conditions or variables that a tester uses to determine whether an application software or software system works correctly. In some embodiments, a query statement may be generated based on the change representation 114, and then a test case 116 is selected from the test case library. The test case library 118 stores a plurality of test cases and may include fields associated with the change representation 114, such as the file name, the function name, and the code line. In addition, after obtaining the test case 116, the computing device 110 may further construct a testing environment, automatically run the test case 116, and evaluate the code change according to a running log.

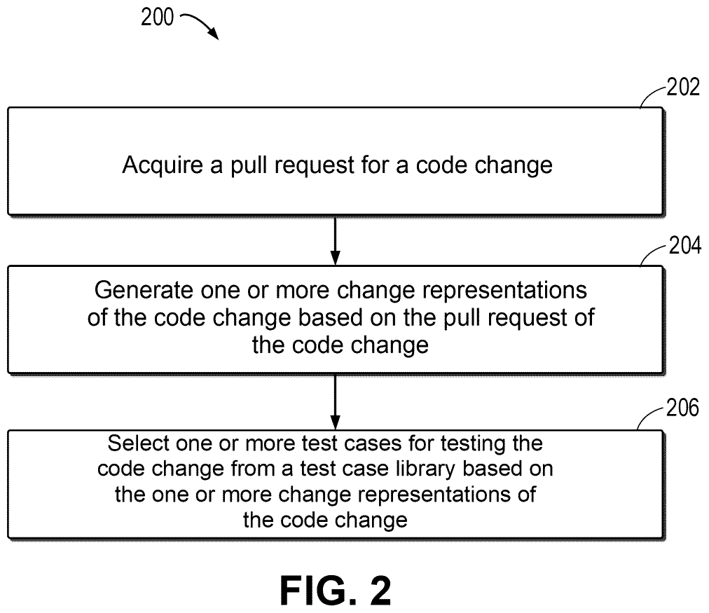

The example environment 100 in which an embodiment of the present disclosure can be implemented has been described above in conjunction with FIG. 1. A flow chart of a method 200 for selecting test cases according to an embodiment of the present disclosure will be described below in conjunction with FIG. 2.

FIG. 2 shows a flow chart of a method 200 for selecting test cases according to an embodiment of the present disclosure. At block 202, a pull request for a code change may be acquired. For example, in combination with FIG. 1, the computing device 110 may acquire the pull request 112 for the code change. At block 204, one or more change representations of the code change may be generated based on the pull request of the code change, wherein the change representation at least includes a file name, a function name, and a code line which are associated with the code change. For example, in combination with FIG. 1, the computing device 110 may generate the one or more change representations 114 of the code change based on the pull request 112 of the code change.

At block 206, one or more test cases for testing the code change may be selected from a test case library based on the one or more change representations of the code change. For example, in combination with FIG. 1, the computing device 110 may select the one or more test cases 116 for testing the code change from the test case library 118 based on the one or more change representations 114 of the code change.

Thus, according to the method 200 of the embodiments of the present disclosure, a test case for verifying a code change can be automatically selected, thereby improving testing efficiency, accelerating testing speeds, helping to timely discover and solve problems, and shortening the software development cycle, while reducing the workload of manual selection by a tester, lowering labor costs, and avoiding the influence of human factors on test case selection.

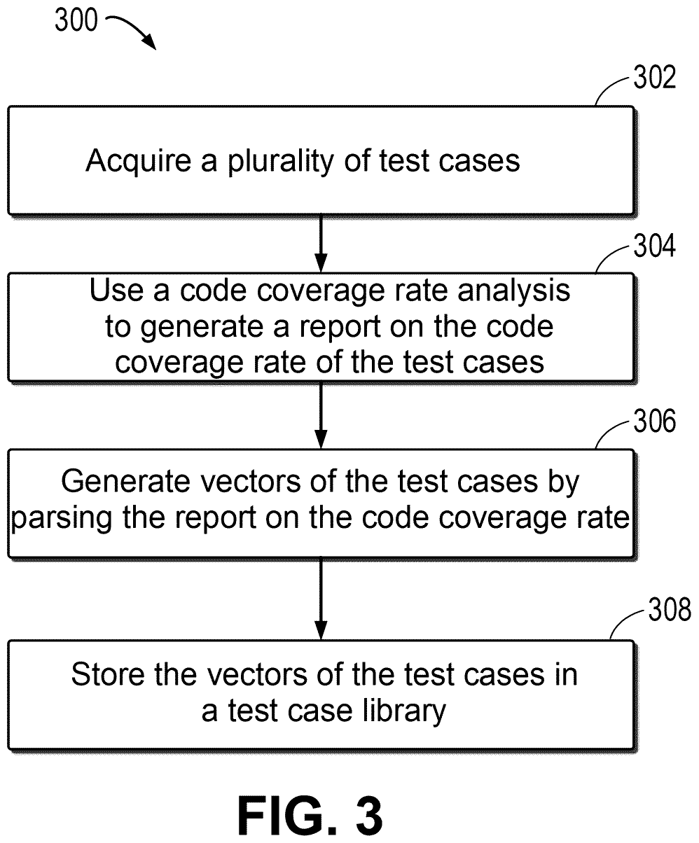

FIG. 3 shows a schematic diagram of a process 300 of constructing a test case library according to an embodiment of the present disclosure. It should be understood that the test case library is a database that stores test cases. In some embodiments, the test case library may store scripts of actual test cases. In some embodiments, the test case library may store an index of test cases and acquire scripts of the test cases from other memory pools through this index. At block 302, a plurality of test cases may be acquired. In software development, “test cases” refer to a group of detailed operational steps, input data, expected results, and possible boundary conditions, aimed at verifying the specific functions, behaviors, or performance of a software system. Test cases are basic units of a testing process and are written by a software tester or a developer to ensure that the software can run correctly in various situations. By performing the test cases, potential defects, errors, or anomalies may be identified, and it may be ensured that the software system meets design specifications and user requirements. The test cases typically cover different testing scenarios and cases to comprehensively cover all aspects of software, including functionality, performance, security, etc. For example, a plurality of test cases “testcase_1. sh”, “testcase_2. Sh”, . . . , and “testcase_n. sh” may be acquired.

At block 304, a code coverage rate tool may be used to generate a report on a code coverage rate of the test cases. The code coverage rate tool is a software development tool used to measure the degree to which the code is covered by the test cases. The code coverage rate report is generated by analyzing code paths as well as which code is executed and which code is not executed during program execution. These tools may help the developers evaluate the quality and completeness of their test cases, as well as determining potential untested parts in the code. By understanding the coverage rate of the code, the developer may make more accurate testing plans and decisions to improve software quality and stability. A report on the code coverage rate of the test cases may be generated through the code coverage rate tool. For example, a generated report may be as shown in Table 1:

TABLE 1
Test Report

| File name | Function name | Active line | Anchor point | Test case |
|---|---|---|---|---|
| file 1 | getattr | 96-119; | FM_MTREE_ | testcase_1.sh |
| | | 124-148; | SNAP_RDLOCK | |
| | | 185-243; | fm_dm1_getattr_ | |
| | | . . . | intern | |
| file 2 | access | 201-230; | fm_get_path_on_ | testcase_2.sh |
| | | 245-260; | cond | |
| | | . . . | | |

The file name represents the file for which the test case was run, the function name represents the function for which the test case was run, the active line represents the number of code lines covered by the test case, and the anchor point is used to improve accuracy of usage and is marked as a reasonable checkpoint reached by the code logic, which may be filtered according to conditions in subsequent use. It should be understood that Table 1 only shows examples of two test cases, and the test cases may be performed one by one sequentially.

At block 306, vectors of the test cases may be generated by parsing the report on the code coverage rate. It should be understood that the vectors of the test cases are representations of the test cases. In some embodiments, the format of the vectors of the test cases may be [file name, function name, code line, test case name]. In some embodiments, the anchor point may further be added to the vectors to improve the accuracy of usage. For example, the vector of each test case may be generated according to the content of Table 1. As mentioned earlier, the test cases may be performed one by one sequentially to generate the vectors of each test case. In addition, when the file name and/or the function name changes, the same test case may correspond to different active lines and/or anchor points. That is to say, the same test case may correspond to a plurality of different vectors. At block 308, the vectors of the test cases may be stored in a test case library. The test case library may be constructed by pre-running and parsing the test cases. For example, the test case library may store the representations or vectors of the test cases, so that when submitting the code change, the test cases may be automatically selected to test the code change.

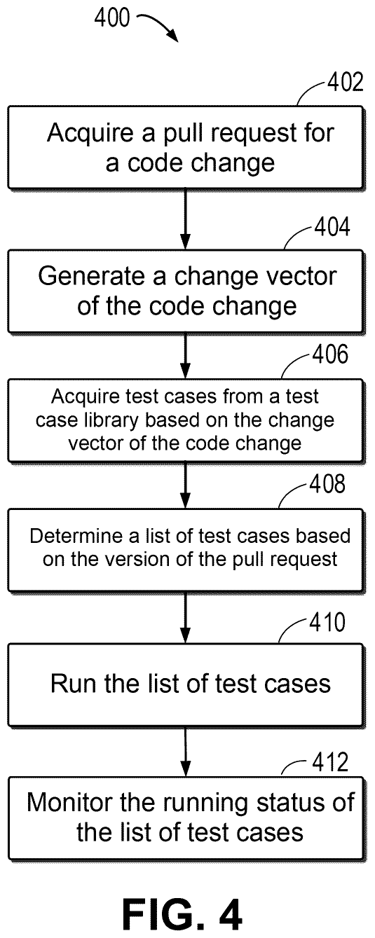

FIG. 4 shows a schematic diagram of a process 400 of executing code testing according to an embodiment of the present disclosure. At block 402, a pull request for a code change may be acquired. The pull request is used in collaborative code development and review processes. In a project that uses a distributed control system to manage code, a developer typically works on his/her own branches and then submits his/her changes to a shared repository. The developer typically provides information about the descriptions of the code changes, their objectives, and the issues addressed, in order for reviewers to understand and evaluate these changes. For example, in code development, a pull request may be a link to the code change, and specific details of the code change can be visualized through the link.

At block 404, the change vector of the code change may be generated. For example, the change vector of the code change may be generated on the basis of the pull request for the code change. In addition, the change vector of the code change is also called a change representation. When generating the change representation of the code change, the change type of the code change may be determined, and then the change representation is determined according to the change type. In some embodiments, when the change type is a line addition type, the change representation may be determined based on the line before and the line after the newly added line. For example, if a new code line is added in an existing function, the coverage status of the previous line and the subsequent line of the code line may be checked, and [file name, function name, code line+1, code line−1] are added to the change representation of the code. In some embodiments, when the change type is a segment deletion type, the change representation may be determined based on the plurality of lines corresponding to the deleted code segment, wherein the segment includes code segments of the plurality of code lines. For example, if a code segment in an existing function is deleted, the coverage status of each line in the deleted code segment may be checked by searching the previously generated database, and [file name, function name, each code line in the delete segment] are added to the change representation of the code.

In some embodiments, when the change type is a segment modification type, the change representation may be determined based on the plurality of lines corresponding to the modified segment. For example, if a code segment in an existing function is modified, the coverage status of each line of the code segment may be checked, and [file name, function name, each code line in the modified segment] are added to the change representation of the code. In addition, test cases with relatively high coverage rates and the same function may be selected to improve accuracy. In some embodiments, when the change type is a function addition type, the change representation may be determined based the file name corresponding to the newly added function. For example, if a new function is added, a plurality of test cases with the same file name as the new function may be selected.

In some embodiments, when the change type is a function deletion type, the change representation may be determined based on the function name of the deleted function. For example, if an existing function is deleted, a test case represented by code that includes [file name, function name, any code line] may be selected without any restrictions on the code line. In some embodiments, when the change type is a file deletion type, the change representation may be determined based on the file name of the deleted file.

At block 406, test cases may be acquired from the test case library based on the change vector of the code change. For example, test cases may be acquired through a pseudocode “select rec.casename from rec and pull where rec.vectors intersect or include pull.vectors”. As described in process 300 in FIG. 3, the test case library stores test cases and corresponding test case vectors. Therefore, test cases corresponding to the code change may be acquired through the change vector of the code change.

At block 408, a list of test cases may be determined based on the version of the pull request. As mentioned earlier, the pull request for the code change may correspond to one or more code change vectors, and a list of test cases may be prepared to test the one or more changes. In addition, it is also necessary to check and confirm the version of the pull request, so as to construct the corresponding testing environment and determine the list of test cases.

At block 410, the list of test cases may be run. For example, for the pull request for the code change, each test case in the list of test cases is run one by one. It should be understood that after the test cases have been determined, running the list of test cases one by one may be automatically executed without human intervention. In some embodiments, a corresponding running log may be generated when running the test cases. At block 412, the running status of the list of test cases may be monitored. For example, the running status of each test case may be determined by parsing the test case running log. For example, it may be determined whether the corresponding code change meets expectations. In addition, a report on the code coverage rate of the code change may be generated.

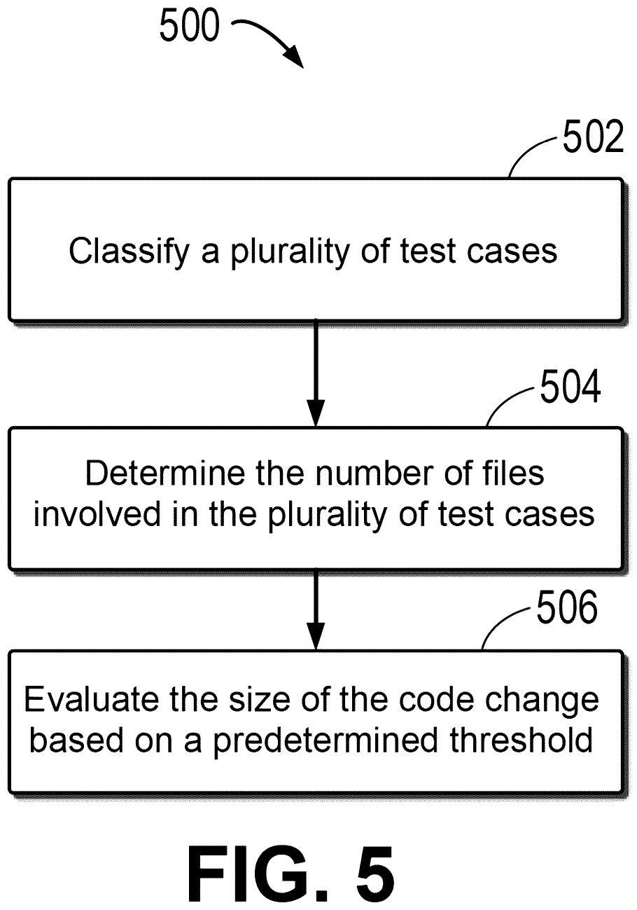

FIG. 5 shows a schematic diagram of a process 500 of evaluating a code change according to an embodiment of the present disclosure. As mentioned earlier, test cases may be automatically selected based on the code change. The process 500 of evaluating a code change described in FIG. 5 may evaluate the size of the code change based on the test cases. At block 502, a plurality of test cases may be classified. In some embodiments, one or more file names corresponding to one or more test cases may be acquired. In some embodiments, the test cases may be classified based on the file names of the test cases. In some embodiments, test case categories for the one or more test cases may be generated based on the one or more file names. For example, the test case “testcase_1. sh” corresponds to the file “file_1”, and “file_1” may be used as the category for the test case “testcase_1. sh”. In addition, “testcase_2. sh” corresponds to the file “file_2”, and “file_2” may be used as the category for the test case “testcase_2. sh”. At block 504, the number of files involved in the plurality of test cases may be determined. In some embodiments, the file number corresponding to the code change may be determined based on the test case categories. For example, it may be determined that the number of files involved in the plurality of test cases is 50.

At block 506, the size of the code change may be evaluated based on a predetermined threshold. In some embodiments, the change level for indicating the size of the code change may be determined based on the file number and the predetermined threshold. For example, if a module has a total of 200 files and the number of files involved in the plurality of test cases is 50, then the proportion involved in the code change is 40%. In some embodiments, the predetermined threshold may be set to be 30%, and it is defined that the code change, when greater than the predetermined threshold, is a large code change. In some embodiments, the predetermined threshold may be set to be 50%, and it is defined that the code change, when greater than the predetermined threshold, is a large code change. Therefore, it may be determined that the code change this time is relatively small. A larger code change usually means a higher risk, so evaluating the size of the code change may help developers understand the degree of influence of the change on stability and functionality and develop testing strategies accordingly.

In some embodiments, a plurality of thresholds may be pre-set, and the levels of code change sizes may be set correspondingly. In some embodiments, the size of the code change may be evaluated based on the functions involved in a plurality of test cases. In some embodiments, the size of the code change may be evaluated based on the number of lines involved in a plurality of test cases. In some embodiments, the size of the code change may be evaluated in combination with the files, the functions, and the number of lines involved in the code change.

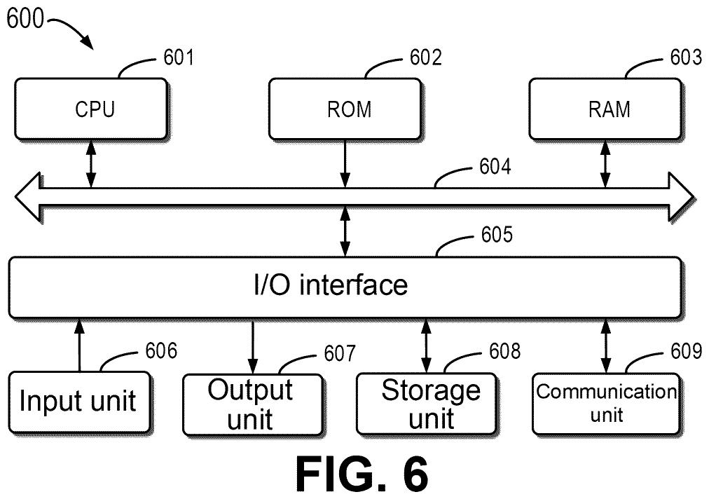

FIG. 6 shows a schematic block diagram of a device 600 that may be used to implement an embodiment of the present disclosure. The device 600 may be a device or an apparatus as described in the embodiments of the present disclosure. As shown in FIG. 6, the device 600 includes a central processing unit (CPU) 601 that can perform various appropriate actions and processing according to computer program instructions stored in a read-only memory (ROM) 602 or computer program instructions loaded from a storage unit 608 to a random access memory (RAM) 603. Various programs and data required for the operation of the storage device 600 may also be stored in the RAM 603. The CPU 601, the ROM 602, and the RAM 603 are connected to each other through a bus 604. An input/output (I/O) interface 605 is also connected to the bus 604.

Multiple components in the device 600 are connected to the I/O interface 605, including: an input unit 606, such as a keyboard and a mouse; an output unit 607, such as various types of displays and speakers; a storage unit 608, such as a magnetic disk and a compact disc; and a communication unit 609, such as a network card, a modem, and a wireless communication transceiver. The communication unit 609 allows the device 600 to exchange information/data with other devices via a computer network, such as the Internet, and/or various telecommunication networks.

The various methods or processes described above may be performed by the processing unit 601. For example, in some embodiments, the methods may be implemented as a computer software program that is tangibly included in a machine-readable medium such as the storage unit 608. In some embodiments, part or all of the computer program can be loaded and/or installed onto the device 600 via the ROM 602 and/or the communication unit 609. When the computer program is loaded onto the RAM 603 and executed by the CPU 601, one or more steps or actions of the methods or processes described above may be performed.

In some embodiments, the methods and processes described above may be implemented as a computer program product. The computer program product may include a computer-readable storage medium on which computer-readable program instructions for performing various aspects of the present disclosure are loaded.

The computer-readable storage medium may be a tangible device that may retain and store instructions used by an instruction-executing device. For example, the computer-readable storage medium may be, but is not limited to, an electrical storage device, a magnetic storage device, an optical storage device, an electromagnetic storage device, a semiconductor storage device, or any suitable combination thereof. More specific examples (a non-exhaustive list) of the computer-readable storage medium include: a portable computer disk, a hard disk, a random access memory (RAM), a read-only memory (ROM), an erasable programmable read-only memory (EPROM or flash memory), a static random access memory (SRAM), a portable compact disc read-only memory (CD-ROM), a digital versatile disc (DVD), a memory stick, a floppy disk, a mechanical encoding device, for example, a punch card or a raised structure in a groove with instructions stored thereon, and any suitable combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein may be downloaded from a computer-readable storage medium to various computing/processing devices, or downloaded to an external computer or external storage device via a network, such as the Internet, a local area network, a wide area network, and/or a wireless network. The network may include a copper transmission cable, fiber optic transmission, wireless transmission, a router, a firewall, a switch, a gateway computer, and/or an edge server. A network adapter card or network interface in each computing/processing device receives computer-readable program instructions from a network and forwards the computer-readable program instructions for storage in a computer-readable storage medium in each computing/processing device.

The computer program instructions for performing the operations of the present disclosure may be assembly instructions, instruction set architecture (ISA) instructions, machine instructions, machine-related instructions, microcode, firmware instructions, status setting data, or source code or object code written in any combination of one or more programming languages, including object-oriented programming languages as well as conventional procedural programming languages. The computer-readable program instructions may be executed entirely on a user computer, partly on a user computer, as a stand-alone software package, partly on a user computer and partly on a remote computer, or entirely on a remote computer or a server. In a case where a remote computer is involved, the remote computer may be connected to a user computer through any kind of networks, including a local area network (LAN) or a wide area network (WAN), or may be connected to an external computer (for example, connected through the Internet using an Internet service provider). In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions so as to implement various aspects of the present disclosure.

These computer-readable program instructions may be provided to a processing unit of a general-purpose computer, a special-purpose computer, or another programmable data processing apparatus to produce a machine, such that these instructions, when executed by the processing unit of the computer or another programmable data processing apparatus, generate an apparatus for implementing the functions/actions specified in one or more blocks in the flow charts and/or block diagrams. The computer-readable program instructions may also be stored in a computer-readable storage medium. These instructions cause a computer, a programmable data processing apparatus, and/or another device to operate in a particular manner, such that the computer-readable medium storing the instructions includes an article of manufacture which includes instructions for implementing various aspects of the functions/actions specified in one or more blocks in the flow charts and/or block diagrams.

The computer-readable program instructions can be loaded onto a computer, other programmable data processing apparatuses, or other devices, so that a series of operating steps are performed on the computer, other programmable data processing apparatuses, or other devices to produce a computer-implemented process. Therefore, the instructions executed on the computer, other programmable data processing apparatuses, or other devices implement the functions/actions specified in one or more blocks in the flow charts and/or block diagrams.

The flow charts and block diagrams in the accompanying drawings show the architectures, functions, and operations of possible implementations of the device, the method, and the computer program product according to a plurality of embodiments of the present disclosure. In this regard, each block in the flow charts or block diagrams may represent a module, a program segment, or part of an instruction, the module, program segment, or part of an instruction including one or more executable instructions for implementing specified logical functions. In some alternative implementations, the functions denoted in the blocks may also occur in an order different from that shown in the accompanying drawings. For example, two consecutive blocks may in fact be executed substantially concurrently, and sometimes they may also be executed in a reverse order, depending on the functions involved. It should be further noted that each block in the block diagrams and/or flow charts as well as a combination of blocks in the block diagrams and/or flow charts may be implemented by a dedicated hardware-based system executing specified functions or actions, or by a combination of a dedicated hardware and computer instructions.

The embodiments of the present disclosure have been described above. The above description is illustrative, rather than exhaustive, and is not limited to the disclosed various embodiments. Numerous modifications and alterations are apparent to persons of ordinary skill in the art without departing from the scope and spirit of the illustrated embodiments. The selection of terms as used herein is intended to best explain the principles and practical applications of the various embodiments or the technical improvements to technologies on the market, or to enable other persons of ordinary skill in the art to understand the embodiments disclosed herein.

1. A method for selecting test cases, comprising:
acquiring a pull request for a code change;
generating one or more change representations of the code change based on the pull request of the code change, wherein the change representation at least comprises a file name, a function name, and a code line which are associated with the code change; and
selecting one or more test cases for testing the code change from a test case library based on the one or more change representations of the code change.

2. The method according to claim 1, wherein selecting the one or more test cases from the test case library comprises:
generating one or more query statements based on the one or more change representations; and
selecting the one or more test cases from the test case library based on the one or more query statements.

3. The method according to claim 2, further comprising:
generating a code analysis report for each test case in a test case set;
generating a test case representation for each test case in the test case set based on the code analysis report, wherein the code analysis report comprises a file name, a function name, and a code line which are associated with the test case; and
constructing the test case library that stores the test case set based on the test case representation.

4. The method according to claim 3, further comprising:
generating test case categories for the one or more test cases;
determining a file number corresponding to the code change based on the test case categories; and
determining a change level for indicating the size of the code change based on the file number and a predetermined threshold.

5. The method according to claim 4, wherein generating the test case categories for the one or more test cases comprises:
acquiring one or more file names corresponding to the one or more test cases; and
generating the test case categories for the one or more test cases based on the one or more file names.

6. The method according to claim 1, wherein generating the one or more change representations of the code change comprises:
determining the change type of the code change; and
determining the change representation of the code change based on the change type.

7. The method according to claim 6, wherein determining the change representation of the code change comprises:
determining, in response to the change type being a line addition type, the change representation based on the line before and the line after the newly added line;
determining, in response to the change type being a segment deletion type, the change representation based on the plurality of code lines corresponding to the deleted code segment; and
determining, in response to the change type being a segment modification type, the change representation based on the plurality of code lines corresponding to the modified code segment.

8. The method according to claim 7, wherein determining the change representation of the code change further comprises:
determining, in response to the change type being a function addition type, the change representation based on the file name corresponding to the newly added function;
determining, in response to the change type being a function deletion type, the change representation based on the function name of the deleted function; and
determining, in response to the change type being a file deletion type, the change representation based on the file name of the deleted file.

9. The method according to claim 1, further comprising:
constructing a testing environment for running a test case list based on a change version of the code change, wherein the test case list comprises the selected one or more test cases; and
running each test case in the test case list.

10. The method according to claim 9, further comprising:
generating a running log for each test case by running each test case in the test case list; and
determining the test result of the code change by analyzing the running log.

11. An electronic device, comprising:
a processor; and
a memory coupled to the processor and having instructions stored therein that, when executed by the processor, cause the processor to perform following actions:
acquiring a pull request for a code change;
generating one or more change representations of the code change based on the pull request of the code change, wherein the change representation at least comprises a file name, a function name, and a code line which are associated with the code change; and
selecting one or more test cases for testing the code change from a test case library based on the one or more change representations of the code change.

12. The electronic device according to claim 11, wherein selecting the one or more test cases from the test case library comprises:
generating one or more query statements based on the one or more change representations; and
selecting the one or more test cases from the test case library based on the one or more query statements.

13. The electronic device according to claim 12, wherein the actions further comprise:
generating a code analysis report for each test case in a test case set;
generating a test case representation for each test case in the test case set based on the code analysis report, wherein the code analysis report comprises a file name, a function name, and a code line which are associated with the test case; and
constructing the test case library that stores the test case set based on the test case representation.

14. The electronic device according to claim 13, wherein the actions further comprise:
generating test case categories for the one or more test cases;
determining a file number corresponding to the code change based on the test case categories; and
determining a change level for indicating the size of the code change based on the file number and a predetermined threshold.

15. The electronic device according to claim 14, wherein generating the test case categories for the one or more test cases comprises:
acquiring one or more file names corresponding to the one or more test cases; and
generating the test case categories for the one or more test cases based on the one or more file names.

16. The electronic device according to claim 11, wherein generating the one or more change representations of the code change comprises:
determining the change type of the code change; and
determining the change representation of the code change based on the change type.

17. The electronic device according to claim 16, wherein determining the change representation of the code change comprises:
determining, in response to the change type being a line addition type, the change representation based on the line before and the line after the newly added line;
determining, in response to the change type being a segment deletion type, the change representation based on the plurality of code lines corresponding to the deleted code segment; and
determining, in response to the change type being a segment modification type, the change representation based on the plurality of code lines corresponding to the modified code segment.

18. The electronic device according to claim 17, wherein determining the change representation of the code change further comprises:
determining, in response to the change type being a function addition type, the change representation based on the file name corresponding to the newly added function;
determining, in response to the change type being a function deletion type, the change representation based on the function name of the deleted function; and
determining, in response to the change type being a file deletion type, the change representation based on the file name of the deleted file.

19. The electronic device according to claim 11, wherein the actions further comprise:
constructing a testing environment for running a test case list based on a change version of the code change, wherein the test case list comprises the selected one or more test cases; and
running each test case in the test case list.

20. A non-volatile computer-readable medium having machine-executable instructions stored therein, which when executed by a processor, cause the processor to perform following actions:
acquiring a pull request for a code change;
generating one or more change representations of the code change based on the pull request of the code change, wherein the change representation at least comprises a file name, a function name, and a code line which are associated with the code change; and
selecting one or more test cases for testing the code change from a test case library based on the one or more change representations of the code change.
